(19) United States
(12) Patent Application Publication
(10) Pub. No.: US 2007/0224581 A1
(43) Pub. Date: Sep. 27, 2007

(54) Article of manufacture for individual, family or community prayer time and process for making prayers to Jesus

(76) Inventor: Robert Henry Cybulski JR., Lancaster, PA (US)

Correspondence Address: ROBERT CYBULSKI JR.;GLOWINE LIGHT INC., 145 NORTHVIEW DR., LANCASTER, PA, 17601, US

(21) Appl. No.: 11/389,914

(22) Filed: Mar. 27, 2006

(51) Int. Cl. G09B 19/00

(52) U.S. Cl. 434/245

(57) ABSTRACT

A process for increasing family prayer time with the steps of: 1. Write a prayer request on a prayer request card; 2. Hang the prayer request card on Jesus through hooks on the name with letters JESUS; 3. Pray together as an individual, family or community for the request hanging onto JESUS; 4. Once the prayer is answered, go to the board and move the prayer request card for the answered prayer to the letters THANKS; 5. View and understand the amount of the Lord's providence by observing the number of prayers answered. A preferred embodiment includes the step(s) of 1. Developing a prayer intention; 2. Interactively placing the prayer intention before or on Jesus or God; 3. Generating regular prayer for the intentions. A preferred embodiment includes the step(s) of Acknowledging that the Lord answers prayer requests though visual tracking of the fulfillment of prayer intentions.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of Religious Prayer and more specifically to an article of manufacture for individual, family or community prayer time and process for making prayers to Jesus. Jesus began teaching on prayer over 2000 years ago. He told us to pray and pray often throughout many sections of the Bible as evidenced by:

Example 1 [symbol] Bible—New Testament—Luke 11:9

“So I say to you ask and you will receive, search and you will find, knock, and the door will be opened for you.”

Example 2 [symbol] Bible—New Testament—Mark 11:24

“So I tell you, whatever you ask for in prayer, believe that you have received it, and it will by yours”

Example 3 [symbol] Bible—New Testament—Matthew 21:22

“And whatever you ask in prayer, you will receive, if you have faith.”

Example 4 [symbol] Bible—New Testament—John 14:13

“Whatever you ask in my name, I will do it, that the Father may be glorified in the Son”

In fact, Jesus is even more specific when he says that when 2 or more pray,

Example 5 [symbol] Bible—New Testament—Matthew 18:20

For where two or three are gathered in my name, there am I in the midst of them.”

During a recent prayer session, the inventor found that Jesus requested that we pray more! The prayer board is a vision from that prayer session. The board's mission is to significantly increase prayer at home.

There are two similar concepts to increase prayer. In many churches, there are hymn boards. The hymn boards are used to display the number of the next song during church services. The second similar concept is a prayer journal. The journal allows for the writing of prayer requests on a daily basis.

The deficiency in the hymn boards is that they don't really track prayer requests or the Lord's provdience. Although, songs are also prayers, the hymn boards don't focus on the prayer intention of the song.

The deficiency in the prayer journal is that it is visually difficult to track the answering of prayers and the daily prayer activity needs to be re-written regularly for ongoing prayers.

### BRIEF SUMMARY OF THE INVENTION

The primary object of the invention is To increase prayer among individuals, families and communities.

Another object of the invention is To make prayer time to be family or communal prayer time.

Another object of the invention is To visually hang prayer requests upon Jesus.

A further object of the invention is To provide a functional and decorative center of attention for prayer.

Yet another object of the invention is To see providence from the Lord by observing the answering of prayer requests.

Other objects and advantages of the present invention will become apparent from the following descriptions, taken in connection with the accompanying drawings, wherein, by way of illustration and example, an embodiment of the present invention is disclosed. In accordance with a preferred embodiment of the invention, there is disclosed an article of manufacture for prayer time comprising: Decorative board that hangs on the wall or sits upon a table as a visual reminder of the need for prayer, Write a prayer request on a prayer card and hang it on the J E S U S hooks, Place to thank the Lord for answering prayer requests through the T H A N K S hooks, Prayer cards that contain the name and the prayer intention and come in many shapes and colors, and Method to hang the prayer intentions on the J E S U S or T H A N K S.

In accordance with a preferred embodiment of the invention, there is disclosed a process for family, individual or communal prayer time comprising the steps of: Write a prayer request on a prayer request card Hang the prayer request card on Jesus through hooks on the name J E S U S, Pray together as an individual, family or community for the request hanging onto J E S U S Once the prayer is answered, go to the board and move the prayer request card for the answered prayer to the letters T H A N K S, View, understand and thank the Lord for the amount of the Lord's providence by observing the number of prayers answered

### BRIEF DESCRIPTION OF THE DRAWINGS

FIG. 1—Title—Prayer Board Basic Layout—is a cross sectional view of the dimensions of the Board

FIG. 2—Title—Letters and the Board—is an elevation view that shows the additions of the lettering on the Board

FIG. 3—Title—Letters and Hooks—is an elevation view that shows the addition of hooks to the letters

FIG. 4—Title—Prayer Card Holder—is an elevation view that shows the addition of the capability hold empty prayer tags on the Board

FIG. 5—Title—Board Titles—is an elevation view that add the titles to the Board

FIG. 6—Prayer Flow Chart—is a flow chart that explains the usage of the Prayer Board

FIG. 7—Prayer Board Pictures—is a set of actual pictures of prayer boards

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

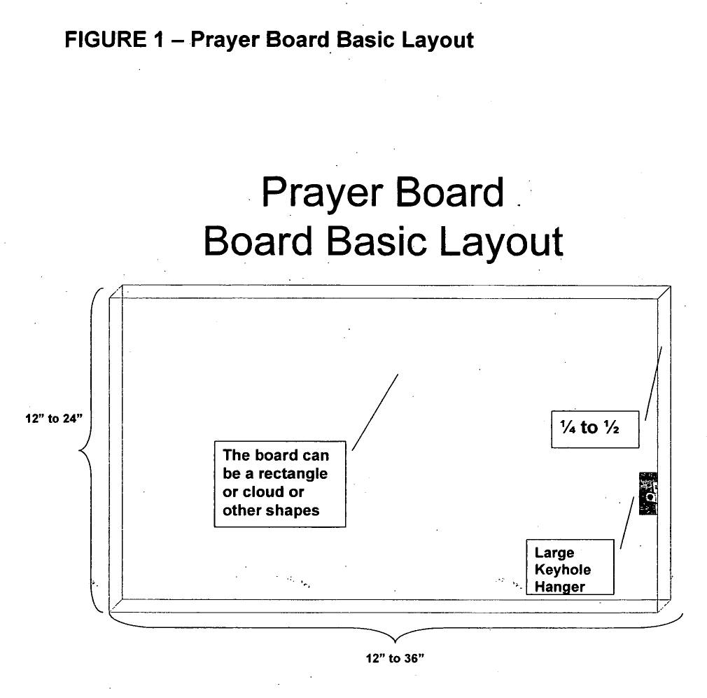

The first figure (FIG. 1) is representative of the basic outline of the Prayer Board. It shows the board as a rectangle with a thickness of either ¼″ or ½″. The board dimensions can range from 12″×12″ to 24″×36.″ The smaller board is targeted at a child's room. The larger boards would be targeted for a church or Christian institution. The higher end board will also be available in different shapes. Example shapes are rectangle, clouds or a Ten Commandment look and feel.

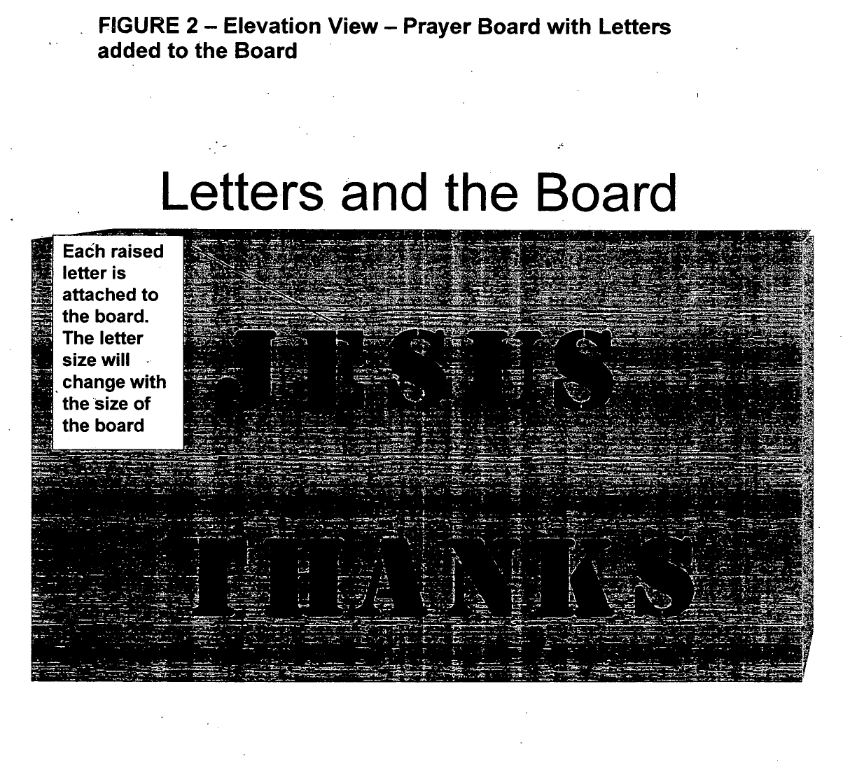

As we turn to FIG. 2, please notice that we've given the board a wood grain finish. The board may also come in metal. Additionally, we've added letters to the board that spell Jesus and Thanks. The letters will range in size correlating to the board size as mentioned in the explanation of FIG. 1 The letters will also be “raised” from the board.

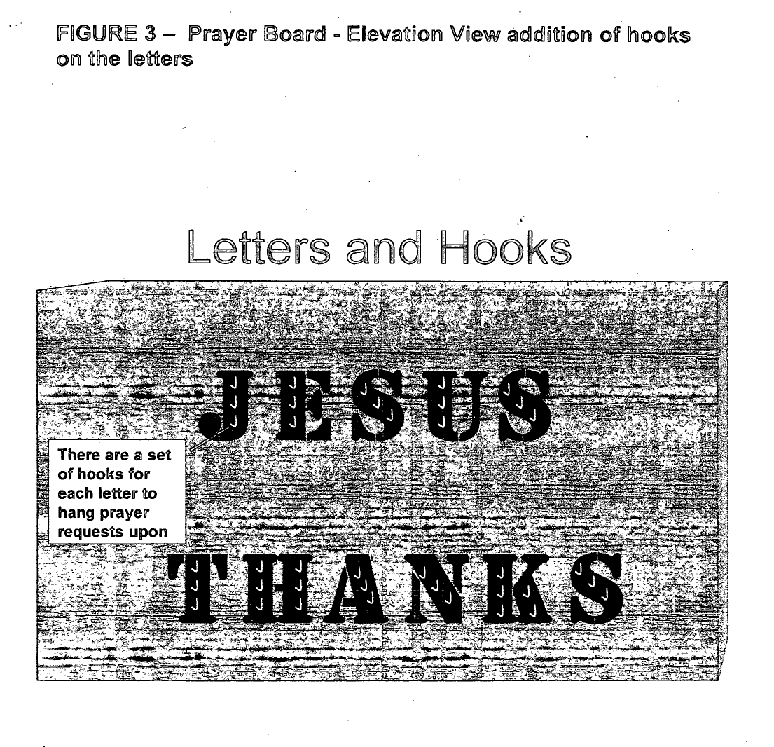

The additional trait for FIG. 3 is the hooks on the letters. Each letter will have between 1-2 hooks screwed into them. The purpose of the hooks is to hang prayer requests upon the hooks spelling Jesus. And, once the request is answered, we move the request to the letters spelling the word Thanks. The hooks can hold multiple requests.

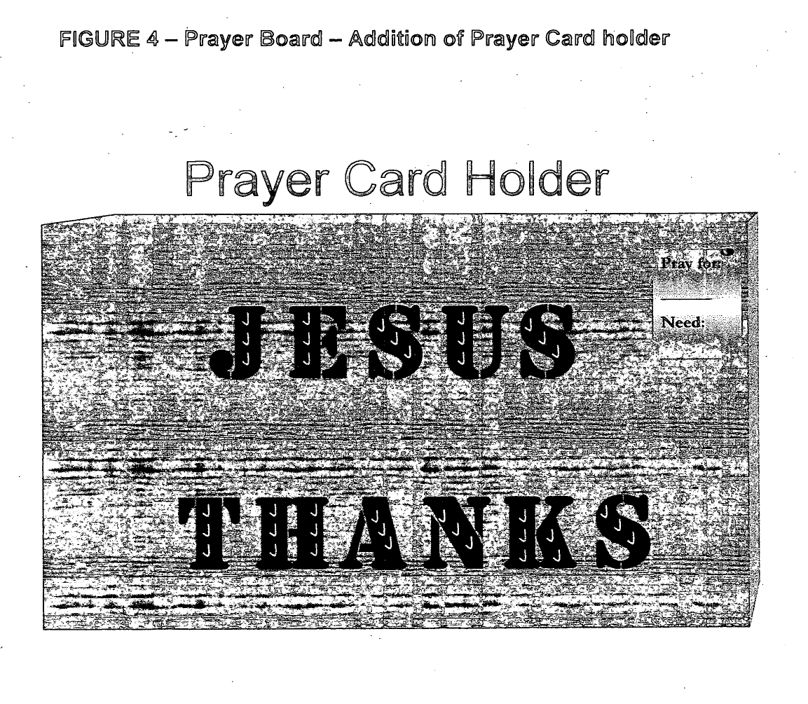

For FIG. 4, we add holder for the prayer cards. The prayer cards will have the text of:

1. Pray for: <insert name>

2. Need: <insert prayer intention>

Or

3. Maybe empty to write free form requests on the cards.

The people that are praying will write the intention. The prayer card holder can be a separate hook, a shelf or a small box.

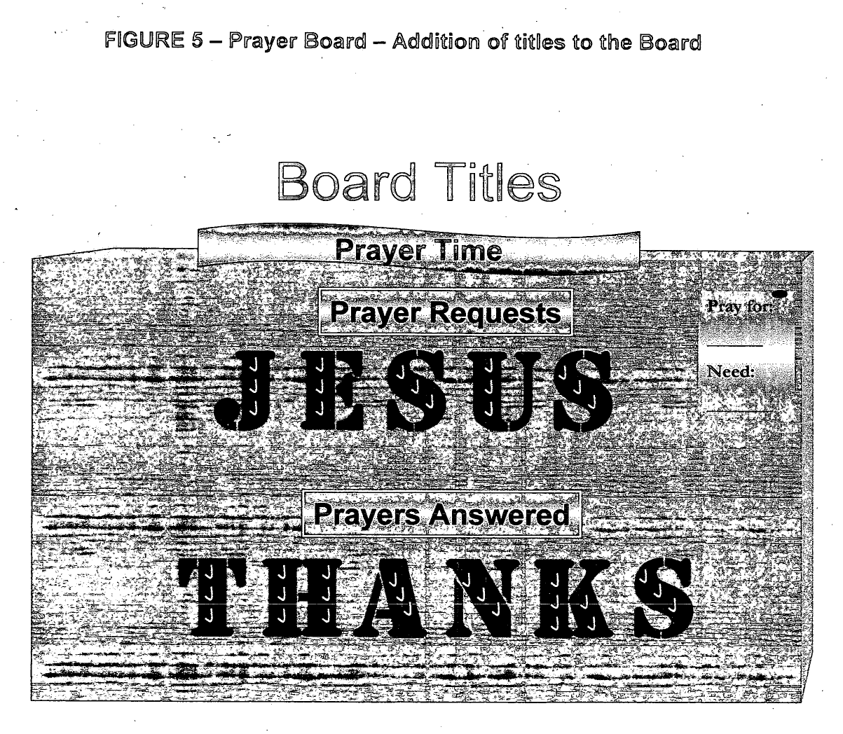

On FIG. 5; we've added titles above the letters that spell JESUS and THANKS. The titles exist to assist the purchaser of the board understand the sections of the board. The title above JESUS is “Prayer Requests.” The title above THANKS is “Prayers Answered.” The title may be positioned above the letters or on the smaller objects off to the side and placed on a heart or cross.

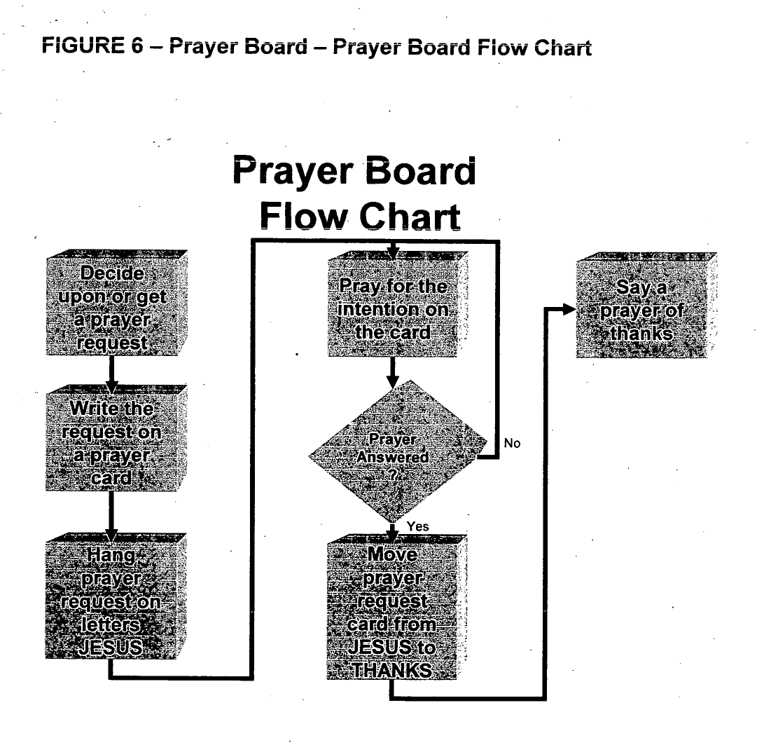

Our flow chart (FIG. 6) shows the 7 easy steps to effectively use the prayer board. The first step is to get a prayer intention from someone or have an intention that you need to pray for. Step 2 is to write the prayer intention on a prayer card. Once the writing is complete, Step 3 involves hanging the interntion on the letters JESUS on the board. The next step is the most important step. The person, family or community prays for the intention on the written on on the card. The person or family will pray at least daily for the intention. Then, the person or family watches for their prayer to be answered. Once the prayer is answered, we go to Step 6 which is to move the prayer card from the letters JESUS to the letters THANKS because we are thanking God for answering the prayer. For the final step, we would say a prayer of Thanksgiving for the answering of the prayer intention.

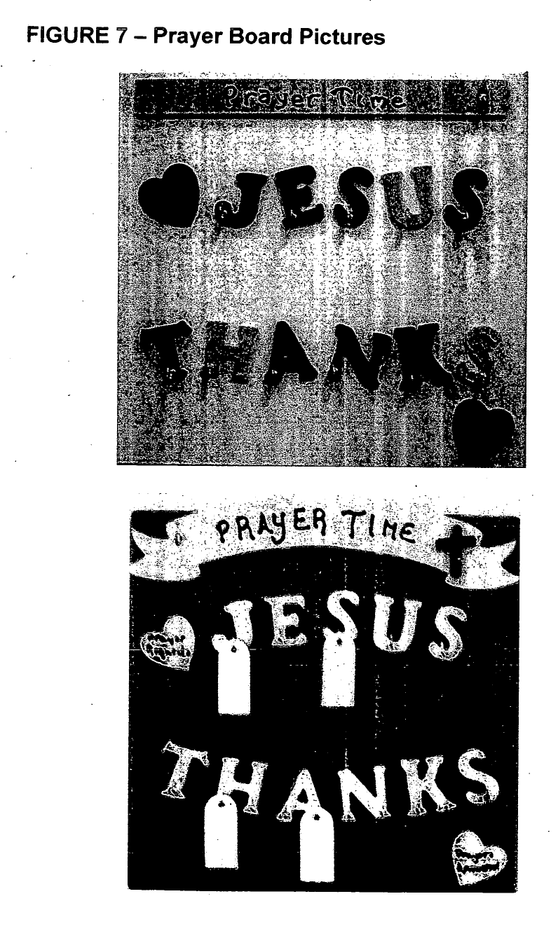

FIG. 7 actually depicts current pictures of Prayer Boards.

What is claimed is:

1. An article of manufacture for individual, family or community prayer time comprising:
Decorative board that hangs on the wall or sits upon a table as a visual reminder of the need for prayer;
Write a prayer request and hang it on Jesus through hooks on the name J E S U S;
Place to thank the Lord for answering prayer requests through hooks on the word T H A N K S;
Prayer cards that contain the name and the prayer intention; and
Method to hang the prayer intentions on the J E S U S or T H A N K S sections of the board

2. A process for family, individual or communtiy prayer time comprising the steps of:
Write a prayer request on a prayer request card
Hang the prayer request card on Jesus through hooks on the name J E S U S;
Pray together as an individual, family or community for the request hanging onto J E S U S
Once the prayer is answered, go to the board and move the prayer request card for the answered prayer to the letters T H A N K S;
View and understand the amount of the Lord's providence by observing the number of prayers answered

3. A process for family prayer time as claimed in claim 2 further comprising the step(s) of
Developing a prayer intention;
Interactively placing the prayer intention on Jesus or God;
Generating regular prayer for the intentions

4. A process for family prayer time as claimed in claim 3 further comprising the step(s) of
Acknowledging that the Lord answers prayer requests;
Visual tracking on fulfillment of prayer intentions
